(19) United States
(12) Patent Application Publication
(10) Pub. No.: US 2017/0228890 A1
(43) Pub. Date: Aug. 10, 2017

(54) OBJECT DETECTION METHOD AND COMPUTER DEVICE

(71) Applicant: Huawei Technologies Co., Ltd., Shenzhen (CN)

(72) Inventors: Shu LIU, Hong Kong (CN); Jiaya JIA, Hong Kong (CN); Yadong LU, Shenzhen (CN)

(21) Appl. No.: 15/425,756

(22) Filed: Feb. 6, 2017

(30) Foreign Application Priority Data
Feb. 6, 2016 (CN) 201610084119.0

(51) Int. Cl. G06T 7/73; G06K 9/42; G06K 9/52; G06T 7/11

(52) U.S. Cl. CPC G06T 7/74; G06T 7/11; G06K 9/42; G06K 9/52

(57) ABSTRACT

Embodiments of the present invention disclose an object detection method and a computer device. The method includes: obtaining a to-be-processed image; obtaining, according to the to-be-processed image, n reference regions used to identify a to-be-detected object in the to-be-processed image, and n detection accuracy values, of the to-be-detected object, corresponding to the n reference regions; determining sample reference regions in the n reference regions, where coincidence degrees of the sample reference regions is greater than a preset threshold; and determining, based on the sample reference regions, a target region corresponding to the to-be-detected object, where the target region is used to identify the to-be-detected object in the to-be-processed image. Implementation of the embodiments of the present invention helps improve accuracy of detecting a location of an object.

### CROSS-REFERENCE TO RELATED APPLICATION

This application claims priority to Chinese Patent Application No. 201610084119.0, filed on Feb. 6, 2016, which is hereby incorporated by reference in its entirety.

### TECHNICAL FIELD

Embodiments of the present invention relate to the field of image processing technologies, and specifically, to an object detection method and a computer device.

### BACKGROUND

Object detection refers to a process in which an object computer marks out an object in an input image, and is a basic issue in machine vision. As shown in FIG. 1, an image is input, the image does not have any mark, and an image in which specific locations of detected objects are marked is output. Object detection is widely applied in daily life. For example, a camera can automatically detect a potential to-be-detected object and automatically focus on the object, a pedestrian is automatically detected in video surveillance, or a self-driving system automatically detects an obstacle. These object detection devices can efficiently provide accurate results to ensure commercial application. Currently, people mainly adopt a potential region classification method to detect an object in an image. An execution process of the method is shown in FIG. 2. First, in an input image, quite a lot of regions that may include an object (there may be up to two thousand regions in each image) are generated; then, these regions are converted into a same size; then, these converted regions are classified by using a region based convolutional neural network (RCNN) classifier; and finally, according to detection accuracy values output by the classifier, a region with a relatively high detection accuracy value is selected as an output. In the foregoing solution, the generated regions in the image are of great redundancy, that is, a same object may be included in many regions, and because these regions include the object, relatively high scores can be determined for these regions. As a result, final results are also of great redundancy, thereby causing detection efficiency of an object detection device to be relatively low.

To resolve the foregoing problem that the detection efficiency of the object detection device is relatively low, an existing solution mainly uses a maximum suppression method, in which the object detection device selects a region currently having a highest score each time, and then deletes a region that has a relatively high coincidence degree with the region currently having a highest score. This process is repeated until all regions are selected or deleted.

However, after a detection accuracy value of a region in an image is high enough, a score of a candidate region and actual location accuracy of the candidate region are not strongly correlated (a Pearson correlation coefficient is lower than 0.3). Therefore, it is difficult to guarantee accuracy of a target region that is determined in a manner in which a region having a highest score is selected each time but information of another region is not used.

### SUMMARY

Embodiments of the present invention provide an object detection method and a computer device, which help improve accuracy of detecting a location of an object by the computer device.

According to a first aspect, an embodiment of the present invention provides an object detection method, including:

obtaining a to-be-processed image;

obtaining, according to the to-be-processed image, n reference regions used to identify a to-be-detected object in the to-be-processed image, and n detection accuracy values, of the to-be-detected object, corresponding to the n reference regions, where n is an integer greater than 1;

determining sample reference regions in the n reference regions, where coincidence degrees between the sample reference regions and a reference region that corresponds to a maximum value in the n detection accuracy values is greater than a preset threshold; and

determining, based on the sample reference regions, a target region corresponding to the to-be-detected object, where the target region is used to identify the to-be-detected object in the to-be-processed image.

With reference to the first aspect, in some possible implementation manners, the determining, based on the sample reference regions, a target region corresponding to the to-be-detected object includes:

normalizing coordinate values of the sample reference regions, to obtain normalized coordinate values of the sample reference regions, where the coordinate value of the sample reference regions is used to represent the sample reference regions;

determining, based on the normalized coordinate values of the sample reference regions, characteristic values of the sample reference regions; and

determining, based on the characteristic values, a coordinate value used to identify the target region corresponding to the to-be-detected object in the to-be-processed image.

It can be learned that, in this embodiment of the present invention, a reference region with a relatively high region coincidence degree is not simply deleted, and instead, sample reference regions with relatively high quality is used to predict a location of a target region of an object, with a relationship of the sample reference regions being fully considered, which helps improve accuracy of detecting a location of the object.

With reference to the first aspect, in some possible implementation manners, after the determining a target region corresponding to the to-be-detected object, the method further includes:

outputting the to-be-processed image with the target region identified.

With reference to the first aspect, in some possible implementation manners, the normalizing coordinate values of the sample reference regions, to obtain normalized coordinate values of the sample reference regions includes:

calculating, based on the following formula, the normalized coordinate values of the sample reference regions:

$${\hat{x}}_{1}^{i} = \frac{{x}_{1}^{i} - \frac{1}{2 Π} {\sum }_{j = 1}^{p} I ( {s}_{j} ) ( {x}_{1}^{j} + {x}_{2}^{j} )}{\frac{1}{Π} {\sum }_{j = 1}^{p} I ( {s}_{j} ) ( {x}_{2}^{j} - {x}_{1}^{j} )} ,$$

where

a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;

x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and \hat{x}₁ⁱ is a normalized horizontal ordinate of the pixel that is located in the upper-left corner of the i^{th} reference region; or

x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and

I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σⱼ₌₁^{p}I(sⱼ), and both i and j are positive integers less than or equal to p.

In the normalization processing step in this embodiment of the present invention, a coordinate value of sample reference regions is normalized, which is conducive to reducing an impact of a reference region with a relatively low detection accuracy value on object detection accuracy, and further improves the object detection accuracy.

With reference to the first aspect, in some possible implementation manners, the characteristic values include a first characteristic value, and the determining, based on the normalized coordinate values of the sample reference regions, characteristic values of the sample reference regions includes:

calculating, based on the following formula, the first characteristic value:

$${u}_{t} = \frac{1}{{\prod }_{t}} {\sum }_{i = 1}^{p} {ℊ}_{t} ( {s}_{i} ) {\hat{b}}_{i} ,$$

where

the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and

\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region; or

\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

It should be noted that \hat{b}ᵢ={\hat{x}₁ⁱ,ŷ₁ⁱ,\hat{x}₂ⁱ,ŷ₂ⁱ} in the foregoing formula of uₜ specifically refers to:

if a currently calculated first characteristic value is a first characteristic value corresponding to an x₁ coordinate of the sample reference regions, \hat{b}ᵢ=\hat{x}₁ⁱ; if a currently calculated first characteristic value is a first characteristic value corresponding to a y₁ coordinate of the sample reference regions, \hat{b}ᵢ=ŷ₁ⁱ; if a currently calculated first characteristic value is a first characteristic value corresponding to an x₂ coordinate of the sample reference regions, \hat{b}ᵢ=\hat{x}₂ⁱ; or if a currently calculated first characteristic value is a first characteristic value corresponding to a y₂ coordinate of the sample reference regions, \hat{b}ᵢ=ŷ₂ⁱ, where the x₁ coordinate corresponds to the foregoing x₁^{j} coordinate, and the x₂ coordinate corresponds to the foregoing x₂^{j} coordinate.

In this embodiment of the present invention, because the first characteristic value is a weighted average of values obtained by using different weighting functions for coordinates of all sample reference regions, an impact of a coordinate value of each sample reference regions on a target region of a to-be-detected object is comprehensively considered for a coordinate value, of the target region of the to-be-detected object, that is determined based on the first characteristic value, which helps improve object detection accuracy.

With reference to the first aspect, in some possible implementation manners, the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ include at least one of the following:

$$\begin{matrix}ℊ ( {s}_{i} ) = exp ( {ρ}_{1} {s}_{i} ) , & ℊ ( {s}_{i} ) = exp ( {ρ}_{2} {s}_{i} ) , & ℊ ( {s}_{i} ) = exp ( {ρ}_{3} {s}_{i} ) , \\ ℊ ( {s}_{i} ) = {( {s}_{i} - {τ}_{1} )}^{\frac{1}{2}} , & ℊ ( {s}_{i} ) = {( {s}_{i} - {τ}_{2} )}^{\frac{1}{2}} , & ℊ ( {s}_{i} ) = {( {s}_{i} - {τ}_{3} )}^{\frac{1}{2}} , \\ ℊ ( {s}_{i} ) = {s}_{i} - {τ}_{1} , & ℊ ( {s}_{i} ) = {s}_{i} - {τ}_{2} , & ℊ ( {s}_{i} ) = {s}_{i} - {τ}_{3} , \\ ℊ ( {s}_{i} ) = min ( {s}_{i} - {τ}_{1} , 4 ) , & ℊ ( {s}_{i} ) = min ( {s}_{i} - {τ}_{2} , 4 ) , & ℊ ( {s}_{i} ) = \begin{matrix}min \\ ( {s}_{i} - {τ}_{3} , 4 ) ,\end{matrix} \\ ℊ ( {s}_{i} ) = \frac{1}{1 + exp ( - {ρ}_{1} {s}_{i} )} , & ℊ ( {s}_{i} ) = \frac{1}{1 + exp ( - {ρ}_{2} {s}_{i} )} , & ℊ ( {s}_{i} ) = \frac{1}{\begin{matrix}1 + exp \\ ( - {ρ}_{3} {s}_{i} )\end{matrix}} \\ ℊ ( {s}_{i} ) = {( {s}_{i} - {τ}_{1} )}^{2} , & ℊ ( {s}_{i} ) = {( {s}_{i} - {τ}_{2} )}^{2} , & ℊ ( {s}_{i} ) = {( {s}_{i} - {τ}_{3} )}^{2} ,\end{matrix} ,$$

where

the ρ1, τ1, ρ2, τ2, ρ3, and τ3 are normalization coefficients.

With reference to the first aspect, in some possible implementation manners, the characteristic values further include a second characteristic value, and the determining, based on the normalized coordinate values of the sample reference regions, characteristic values of the sample reference regions includes:

calculating, based on the following formula, the second characteristic value:

$$M ( \hat{B} ) = \frac{1}{p} {D}^{T} D ,$$

where

M(\hat{B}) is the second characteristic value, the quantity of the sample reference regions is p, p is a positive integer less than or equal to n, a matrix D includes the normalized coordinate values of the sample reference regions, the i^{th} row in the matrix D includes normalized coordinate value of the i^{th} reference region in the sample reference regions, and \hat{B} represents the sample reference regions.

In the embodiments of the present invention, because the second characteristic value is obtained by means of calculation based on a matrix that includes a coordinate of sample reference regions, two-dimensional relationships of coordinates of different sample reference regions are comprehensively considered for a coordinate value, of a target region of a to-be-detected object, that is determined based on the second characteristic value, which helps improve object detection accuracy.

With reference to the first aspect, in some possible implementation manners, the determining, based on the characteristic values, a coordinate value of the target region corresponding to the to-be-detected object includes:

calculating, according to the following formula, the coordinate value of the target region:

$$\begin{matrix}{h}^{1} ( \hat{B} ) = λ + {Λ}_{1}^{T} u ( \hat{B} ) + {Λ}_{2}^{T} m ( \hat{B} ) \\ = {Λ}^{T} R ( \hat{B} ) ,\end{matrix}$$

where

h¹(\hat{B}) is the coordinate value of the target region corresponding to the to-be-detected object, u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B})^{T}, m(\hat{B})^{T}]^{T}, and \hat{B} represents the sample reference regions.

With reference to the first aspect, in some possible implementation manners, a value of the coefficient Λ is determined by using the following model:

$${min}_{Λ} \frac{1}{2} {Λ}^{T} Λ + C {\sum }_{k = 1}^{K} {[ max ( 0 , \vert {\hat{z}}_{1}^{k} - {h}^{1} ( {\hat{B}}_{k} ) \vert - ε ) ]}^{2} ,$$

where

C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

According to a second aspect, an embodiment of the present invention discloses a computer device, including:

an obtaining unit, configured to obtain a to-be-processed image, where

the obtaining unit is further configured to obtain, according to the to-be-processed image, n reference regions used to identify a to-be-detected object in the to-be-processed image, and n detection accuracy values, of the to-be-detected object, corresponding to the n reference regions, where n is an integer greater than 1;

a first determining unit, configured to determine sample reference regions in the n reference regions, where coincidence degrees between the sample reference regions and a reference region that corresponds to a maximum value in the n detection accuracy values is greater than a preset threshold; and

a second determining unit, configured to determine, based on the sample reference regions, a target region corresponding to the to-be-detected object, where the target region is used to identify the to-be-detected object in the to-be-processed image.

With reference to the second aspect, in some possible implementation manners, the second determining unit includes:

a normalizing unit, configured to normalize a coordinate value of the sample reference regions, to obtain normalized coordinate values of the sample reference regions, where the coordinate value of the sample reference regions is used to represent the sample reference regions;

a characteristic value determining unit, configured to determine, based on the normalized coordinate values of the sample reference regions, characteristic values of the sample reference regions; and

a coordinate value determining unit, configured to determine, based on the characteristic values, a coordinate value used to identify the target region corresponding to the to-be-detected object in the to-be-processed image.

With reference to the second aspect, in some possible implementation manners, the normalizing unit is specifically configured to:

calculate, based on the following formula, the normalized coordinate values of the sample reference regions:

$${\hat{x}}_{1}^{i} = \frac{{x}_{1}^{i} - \frac{1}{2 \prod } {\sum }_{j = 1}^{p} I ( {s}_{j} ) ( {x}_{1}^{j} + {x}_{2}^{j} )}{\frac{1}{\prod } {\sum }_{j = 1}^{p} I ( {s}_{j} ) ( {x}_{2}^{j} - {x}_{1}^{j} )} ,$$

where

a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;

x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and x₁ⁱ is a normalized horizontal ordinate of the pixel that is located in the upper-left corner of the i^{th} reference region; or

x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and

I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σᵢ₌₁^{p}I(sⱼ), and both i and j are positive integers less than or equal to p.

With reference to the second aspect, in some possible implementation manners, the characteristic values include a first characteristic value, and the characteristic value determining unit is specifically configured to:

calculate, based on the following formula, the first characteristic value:

$${u}_{t} = \frac{1}{{\prod }_{t}} {\sum }_{i = 1}^{p} {ℊ}_{t} ( {s}_{i} ) {\hat{b}}_{i} ,$$

where

the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and

\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region; or

\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

It should be noted that \hat{b}ᵢ={\hat{x}₁ⁱ,ŷ₁ⁱ,\hat{x}₂ⁱ,ŷ₂ⁱ} in the foregoing formula of uᵢ specifically refers to:

if a currently calculated first characteristic value is a first characteristic value corresponding to an x₁ coordinate of the sample reference regions, \hat{b}ᵢ=\hat{x}₁ⁱ; if a currently calculated first characteristic value is a first characteristic value corresponding to a y₁ coordinate of the sample reference regions, \hat{b}ᵢ=ŷ₁ⁱ; if a currently calculated first characteristic value is a first characteristic value corresponding to an x₂ coordinate of the sample reference regions, \hat{b}ᵢ=\hat{x}₂ⁱ; or if a currently calculated first characteristic value is a first characteristic value corresponding to a y₂ coordinate of the sample reference regions, \hat{b}ᵢ=ŷ₂ⁱ, where the x₁ coordinate corresponds to the foregoing x₁^{j} coordinate, and the x₂ coordinate corresponds to the foregoing coordinate.

With reference to the second aspect, in some possible implementation manners, the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ include at least one of the following:

$$\begin{matrix}ℊ ( {s}_{i} ) = exp ( {ρ}_{1} {s}_{i} ) , & ℊ ( {s}_{i} ) = exp ( {ρ}_{2} {s}_{i} ) , & ℊ ( {s}_{i} ) = exp ( {ρ}_{3} {s}_{i} ) , \\ ℊ ( {s}_{i} ) = {( {s}_{i} - {τ}_{1} )}^{\frac{1}{2}} , & ℊ ( {s}_{i} ) = {( {s}_{i} - {τ}_{2} )}^{\frac{1}{2}} , & ℊ ( {s}_{i} ) = {( {s}_{i} - {τ}_{3} )}^{\frac{1}{2}} , \\ ℊ ( {s}_{i} ) = {s}_{i} - {τ}_{1} , & ℊ ( {s}_{i} ) = {s}_{i} - {τ}_{2} , & ℊ ( {s}_{i} ) = {s}_{i} - {τ}_{3} , \\ ℊ ( {s}_{i} ) = min ( {s}_{i} - {τ}_{1} , 4 ) , & ℊ ( {s}_{i} ) = min ( {s}_{i} - {τ}_{2} , 4 ) , & ℊ ( {s}_{i} ) = \begin{matrix}min \\ ( {s}_{i} - {τ}_{3} , 4 ) ,\end{matrix} \\ ℊ ( {s}_{i} ) = \frac{1}{1 + exp ( - {ρ}_{1} {s}_{i} )} , & ℊ ( {s}_{i} ) = \frac{1}{1 + exp ( - {ρ}_{2} {s}_{i} )} , & ℊ ( {s}_{i} ) = \frac{1}{\begin{matrix}1 + exp \\ ( - {ρ}_{3} {s}_{i} )\end{matrix}} \\ ℊ ( {s}_{i} ) = {( {s}_{i} - {τ}_{1} )}^{2} , & ℊ ( {s}_{i} ) = {( {s}_{i} - {τ}_{2} )}^{2} , & ℊ ( {s}_{i} ) = {( {s}_{i} - {τ}_{3} )}^{2} ,\end{matrix} ,$$

where

the ρ1, τ1, ρ2, τ2, ρ3, and τ3 are normalization coefficients.

With reference to the second aspect, in some possible implementation manners, the characteristic values further include a second characteristic value, and the characteristic value determining unit is specifically configured to:

calculate, based on the following formula, the second characteristic value:

$$M ( \hat{B} ) = \frac{1}{p} {D}^{T} D ,$$

where

M(\hat{B}) is the second characteristic value, the quantity of the sample reference regions is p, p is a positive integer less than or equal to n, a matrix D includes the normalized coordinate values of the sample reference regions, the i^{th} row in the matrix D includes normalized coordinate value of the i^{th} reference region in the sample reference regions, and \hat{B} represents the sample reference regions.

With reference to the second aspect, in some possible implementation manners, the coordinate value determining unit is specifically configured to:

calculate, according to the following formula, the coordinate value of the target region:

$$\begin{matrix}{h}^{1} ( \hat{B} ) = λ + {Λ}_{1}^{T} u ( \hat{B} ) + {Λ}_{2}^{T} m ( \hat{B} ) \\ = {Λ}^{T} R ( \hat{B} ) ,\end{matrix}$$

where to-be-detected object, u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B})^{T}, m(\hat{B})^{T}]^{T}, and \hat{B} represents the sample reference regions.

With reference to the second aspect, in some possible implementation manners, a value of the coefficient Λ is determined by using the following model:

$${min}_{Λ} \frac{1}{2} {Λ}^{T} Λ + C {\sum }_{k = 1}^{K} {[ max ( 0 , \vert {\hat{z}}_{1}^{k} - {h}^{1} ( {\hat{B}}_{k} ) \vert - ε ) ]}^{2} ,$$

where

C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

According to a third aspect, an embodiment of the present invention discloses a computer device, where the computer device includes a memory and a processor that is coupled with the memory, the memory is configured to store executable program code, and the processor is configured to run the executable program code, to perform some or all of steps described in any method in the first aspect of the embodiments of the present invention.

According to a fourth aspect, an embodiment of the present invention discloses a computer readable storage medium, where the computer readable storage medium stores program code to be executed by a computer device, the program code specifically includes an instruction, and the instruction is used to perform some or all of steps described in any method in the first aspect of the embodiments of the present invention.

In the embodiments of the present invention, after n reference regions used to identify a to-be-detected object in a to-be-processed image, and n detection accuracy values, of the to-be-detected object, corresponding to the n reference regions are obtained, and sample reference regions is determined in the n reference regions, a target region corresponding to the to-be-detected object can be determined based on the sample reference regions, where the target region is used to identify the to-be-detected object in the to-be-processed image, coincidence degrees of the sample reference regions is greater than a preset threshold, and the coincidence degrees of the sample reference regions is coincidence degrees between the sample reference regions and a reference region that corresponds to a maximum value in the n detection accuracy values. It can be learned that, in the embodiments of the present invention, a reference region with a relatively high region coincidence degree is not simply deleted, and instead, sample reference regions with relatively high quality is used to predict a location of a target region of an object, with a relationship of the sample reference regions being fully considered, which helps improve accuracy of detecting a location of the object.

### BRIEF DESCRIPTION OF DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of detecting a location of an object in an image in the prior art;

FIG. 2 is a schematic diagram of detecting a location of an object in an image by using a potential region classification method in the prior art;

FIG. 3 is a schematic structural diagram of a computer device according to an embodiment of the present invention;

FIG. 4 is a schematic flowchart of an object detection method according to a method embodiment of the present invention; and

FIG. 5 is a composition block diagram of functional units of a computer device according to an apparatus embodiment of the present invention.

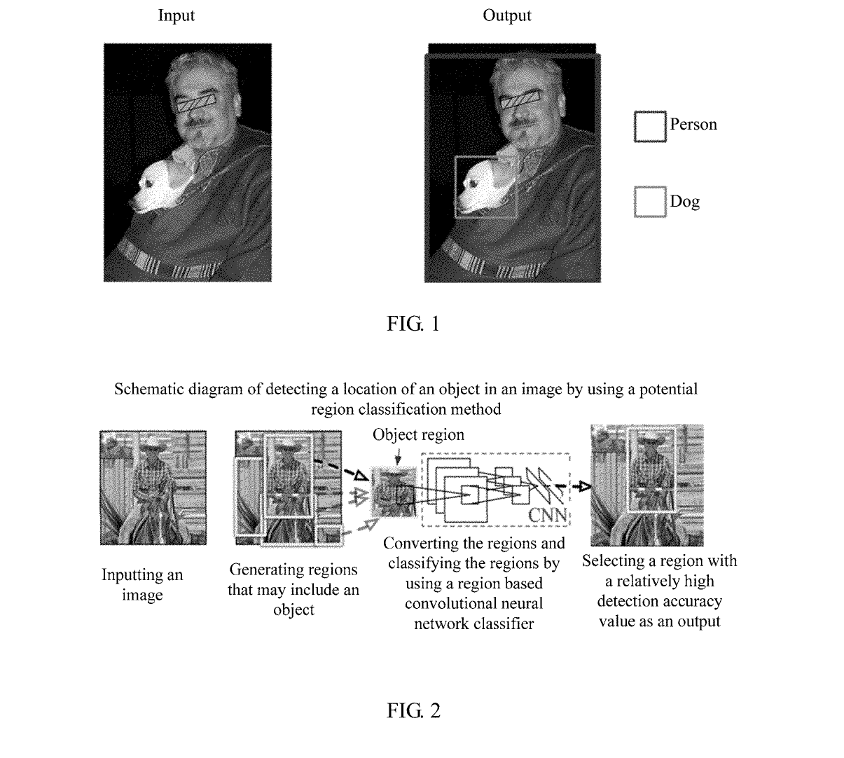

### DESCRIPTION OF EMBODIMENTS

The following clearly describes the technical solutions in the embodiments of the present invention with reference to the accompanying drawings in the embodiments of the present invention.

In the specification, claims, and accompanying drawings of the present invention, the terms “first”, “second”, “third”, “fourth”, and so on are intended to distinguish between different objects but do not indicate a particular order. In addition, the terms “include”, “contain”, and any other variants thereof are intended to cover a non-exclusive inclusion. For example, a process, a method, a system, a product, or a device that includes a series of steps or units is not limited to the listed steps or units, but optionally further includes an unlisted step or unit, or optionally further includes another inherent step or unit of the process, the method, the product, or the device.

To facilitate understanding of the embodiments of the present invention, the following first briefly describes a method of detecting a location of a to-be-detected object in an image by a computer device in the prior art. The computer device first generates, by using a potential region classification method, multiple reference regions used to identify the to-be-detected object, classifies the reference regions by using a region based convolutional neural network (Region Based Convolutional Neural Network, RCNN) classifier, determines detection accuracy values, of the to-be-detected object, corresponding to the reference regions, and then, selects a reference region corresponding to a maximum detection accuracy value as a target region of the to-be-detected object. After a detection accuracy value of a reference region in the image is high enough, a score of the reference region and actual location accuracy of the reference region are not strongly correlated (a Pearson correlation coefficient is lower than 0.3), which makes it difficult to guarantee accuracy of the finally determined target region of the to-be-detected object.

Based on this, an object detection method is proposed in the solutions of the present invention. After obtaining n reference regions used to identify a to-be-detected object in a to-be-processed image, and n detection accuracy values, of the to-be-detected object, corresponding to the n reference regions, and determining sample reference regions in the n reference regions, a computer device may determine, based on the sample reference regions, a target region corresponding to the to-be-detected object, where the target region is used to identify the to-be-detected object in the to-be-processed image, coincidence degrees of the sample reference regions is greater than a preset threshold, and the coincidence degrees of the sample reference regions is coincidence degrees between the sample reference regions and a reference region that corresponds to a maximum value in the n detection accuracy values. It can be learned that, in the embodiments of the present invention, a reference region with a relatively high region coincidence degree is not simply deleted, and instead, sample reference regions with relatively high quality is used to predict a location of a target region of an object, with a relationship of the sample reference regions being fully considered, which helps improve accuracy of detecting a location of the object.

A detailed description is given below.

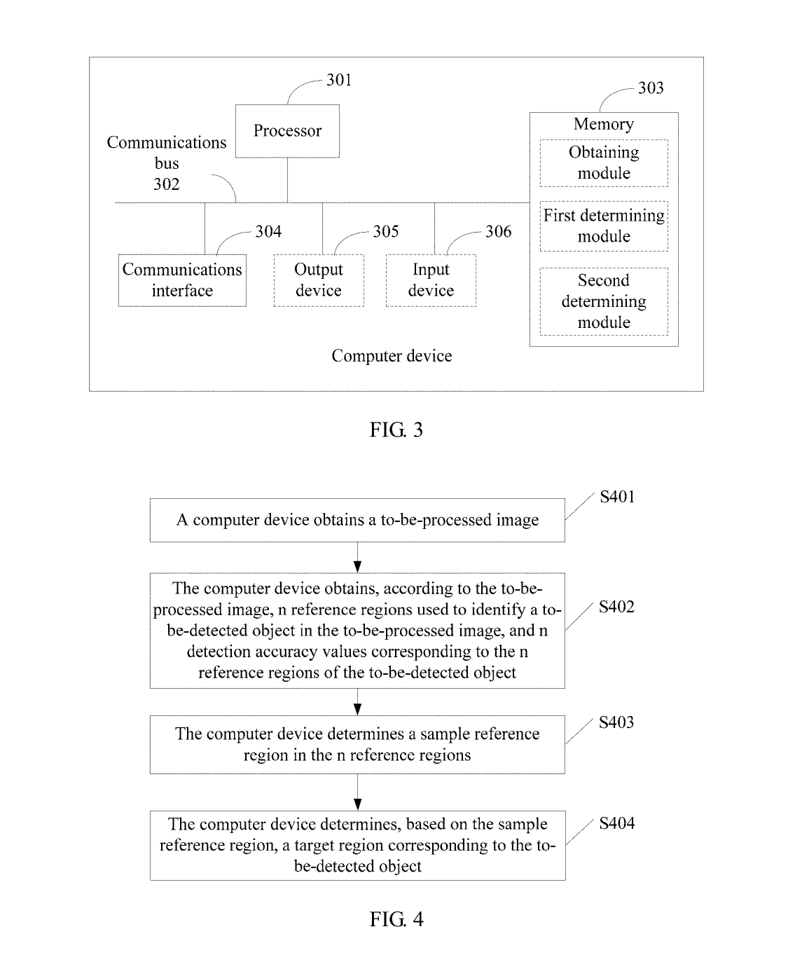

Referring to FIG. 3, FIG. 3 is a schematic structural diagram of a computer device according to an embodiment of the present invention. The computer device includes at least one processor 301, a communications bus 302, a memory 303, and at least one communications interface 304. The processor 301 may be a general purpose central processing unit (CPU), a microprocessor, an application-specific integrated circuit (ASIC), or one or more integrated circuits used to control program execution of the solutions of the present invention. The communications bus 302 may include a channel and transfers information between the foregoing components. The communications interface 304 may be an apparatus using a transceiver or the like, and is configured to communicate with another device or a communications network, such as an Ethernet, a radio access network (RAN), or a wireless local area network (WLAN). The memory 303 may be a read-only memory (read-only memory, ROM) or another type of static storage device that may store static information and instructions, or a random access memory (RAM) or another type of dynamic storage device that may store information and instructions, and may also be an electrically erasable programmable read-only memory (EEPROM), a read-only optical disc (Compact Disc Read-Only Memory, CD-ROM), another optical disc storage medium, optical disc storage medium (including a compact disc, a laser disc, an optical disc, a digital versatile disc, a Blu-ray disc, or the like), or magnetic disc storage medium, another magnetic storage device, or any other medium that can be used to carry or store expected program code in a structural form of an instruction or data and that can be accessed by a computer, but is not limited thereto.

The computer device may further include an output device 305 and an input device 306. The output device 305 communicates with the processor 301 and may display information in multiple manners. The input device 306 communicates with the processor 301 and may accept an input from a user in multiple manners.

In specific implementation, the foregoing computer device may be, for example, a desktop computer, a portable computer, a network server, a palm computer (Personal Digital Assistant, PDA), a mobile phone, a tablet computer, a wireless terminal device, a communications device, an embedded device, or a device that has a structure similar to the structure shown in FIG. 3. A type of the computer device is not limited in this embodiment of the present invention.

The processor 301 in the foregoing computer device can couple the at least one memory 303. The memory 303 pre-stores program code, where the program code specifically includes an obtaining module, a first determining module, and a second determining module. In addition, the memory 303 further stores a kernel module, where the kernel module includes an operating system (for example, WINDOWS™, ANDROID™, or IOS™).

The processor 301 of the computer device invokes the program code to execute the object detection method disclosed in this embodiment of the present invention, which specifically includes the following steps:

running, by the processor 301 of the computer device, the obtaining module in the memory 303, to obtain a to-be-processed image, and obtain, according to the to-be-processed image, n reference regions used to identify a to-be-detected object in the to-be-processed image, and n detection accuracy values, of the to-be-detected object, corresponding to the n reference regions, where n is an integer greater than 1, where

the detection accuracy values, of the to-be-detected object, corresponding to the reference regions may be obtained by means of calculation by using a region based convolutional neural network (Region Based Convolutional Neural Network, RCNN) classifier;

running, by the processor 301 of the computer device, the first determining module in the memory 303, to determine sample reference regions in the n reference regions, where coincidence degrees between the sample reference regions and a reference region that corresponds to a maximum value in the n detection accuracy values is greater than a preset threshold, where

if a coincidence degree corresponding to two reference regions that completely coincide is 1, the preset threshold may be, for example, 0.99 or 0.98; or if a coincidence degree corresponding to two reference regions that completely coincide is 100, the preset threshold may be, for example, 99, 98, or 95, and the preset threshold may be set by a user in advance; and

running, by the processor 301 of the computer device, the second determining module in the memory 303, to determine, based on the sample reference regions, a target region corresponding to the to-be-detected object, where the target region is used to identify the to-be-detected object in the to-be-processed image.

It can be learned that the computer device provided in this embodiment of the present invention does not simply delete a reference region with a relatively high region coincidence degree, and instead, uses sample reference regions with relatively high quality to predict a location of a target region of an object, with a relationship of the sample reference regions being fully considered, which helps improve accuracy of detecting a location of the object.

Optionally, after the processor 301 determines the target region corresponding to the to-be-detected object, the processor 301 is further configured to:

output the to-be-processed image with the target region identified.

Optionally, a specific implementation manner of the determining, by the processor 301 and based on the sample reference regions, a target region corresponding to the to-be-detected object is:

normalizing coordinate values of the sample reference regions, to obtain normalized coordinate values of the sample reference regions, where the coordinate value of the sample reference regions is used to represent the sample reference regions;

determining, based on the normalized coordinate values of the sample reference regions, characteristic values of the sample reference regions; and

determining, based on the characteristic values, a coordinate value used to identify the target region corresponding to the to-be-detected object in the to-be-processed image.

Optionally, a specific implementation manner of the normalizing, by the processor 301, a coordinate value of the sample reference regions, to obtain normalized coordinate values of the sample reference regions is:

calculating, based on the following formula, the normalized coordinate values of the sample reference regions:

$${\hat{x}}_{1}^{i} = \frac{{x}_{1}^{i} - \frac{1}{2 \prod } {\sum }_{j = 1}^{p} I ( {s}_{j} ) ( {x}_{1}^{j} + {x}_{2}^{j} )}{\frac{1}{\prod } {\sum }_{j = 1}^{p} I ( {s}_{j} ) ( {x}_{2}^{j} - {x}_{1}^{j} )} ,$$

where P a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;

x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and \hat{x}₁ⁱ is a normalized horizontal ordinate of the pixel that is located in the upper-left corner of the i^{th} reference region; or

x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and

I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σⱼ₌₁^{p}I(sⱼ), and both i and j are positive integers less than or equal to p.

The preset accuracy value may be set by a user in advance, or may be a reference value obtained by means of calculation according to the maximum value in the n detection accuracy values, which is not uniquely limited in this embodiment of the present invention.

In the normalization processing step in this embodiment of the present invention, a coordinate value of sample reference regions is normalized, which is conducive to reducing an impact of a reference region with a relatively low detection accuracy value on object detection accuracy, and further improves the object detection accuracy.

Optionally, the characteristic values include a first characteristic value, and a specific implementation manner of the determining, by the processor 301 and based on the normalized coordinate values of the sample reference regions, characteristic values of the sample reference regions is:

calculating, based on the following formula, the first characteristic value:

$${u}_{t} = \frac{1}{{\prod }_{t}} {\sum }_{i = 1}^{p} {ℊ}_{t} ( {s}_{i} ) {\hat{b}}_{i} ,$$

where

the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and

\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region; or

\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

It should be noted that \hat{b}ᵢ={\hat{x}₁ⁱ,ŷ₁ⁱ,\hat{x}₂ⁱ,ŷ₂ⁱ} in the foregoing formula of uₜ specifically refers to:

if a currently calculated first characteristic value is a first characteristic value corresponding to an x₁ coordinate of the sample reference regions, \hat{b}ᵢ=\hat{x}₁ⁱ; if a currently calculated first characteristic value is a first characteristic value corresponding to a y₁ coordinate of the sample reference regions, \hat{b}ᵢ=ŷ₁ⁱ; if a currently calculated first characteristic value is a first characteristic value corresponding to an x₂ coordinate of the sample reference regions, \hat{b}ᵢ=\hat{x}₂ⁱ; or if a currently calculated first characteristic value is a first characteristic value corresponding to a y₂ coordinate of the sample reference regions, \hat{b}ᵢ=ŷ₂ⁱ, where the x₁ coordinate corresponds to the foregoing x₁^{j} coordinate, and the x₂ coordinate corresponds to the foregoing x₂^{j} coordinate.

In this embodiment of the present invention, because the first characteristic value is a weighted average of values obtained by using different weighting functions for coordinates of all sample reference regions, an impact of a coordinate value of each sample reference regions on a target region of a to-be-detected object is comprehensively considered for a coordinate value, of the target region of the to-be-detected object, that is determined based on the first characteristic value, which helps improve object detection accuracy.

Optionally, the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ include at least one of the following:

$$\begin{matrix}ℊ ( {s}_{i} ) = exp ( {ρ}_{1} {s}_{i} ) , & ℊ ( {s}_{i} ) = exp ( {ρ}_{2} {s}_{i} ) , & ℊ ( {s}_{i} ) = exp ( {ρ}_{3} {s}_{i} ) , \\ ℊ ( {s}_{i} ) = {( {s}_{i} - {τ}_{1} )}^{\frac{1}{2}} , & ℊ ( {s}_{i} ) = {( {s}_{i} - {τ}_{2} )}^{\frac{1}{2}} , & ℊ ( {s}_{i} ) = {( {s}_{i} - {τ}_{3} )}^{\frac{1}{2}} , \\ ℊ ( {s}_{i} ) = {s}_{i} - {τ}_{1} , & ℊ ( {s}_{i} ) = {s}_{i} - {τ}_{2} , & ℊ ( {s}_{i} ) = {s}_{i} - {τ}_{3} , \\ ℊ ( {s}_{i} ) = min ( {s}_{i} - {τ}_{1} , 4 ) , & ℊ ( {s}_{i} ) = min ( {s}_{i} - {τ}_{2} , 4 ) , & ℊ ( {s}_{i} ) = \begin{matrix}min \\ ( {s}_{i} - {τ}_{3} , 4 ) ,\end{matrix} \\ ℊ ( {s}_{i} ) = \frac{1}{1 + exp ( - {ρ}_{1} {s}_{i} )} , & ℊ ( {s}_{i} ) = \frac{1}{1 + exp ( - {ρ}_{2} {s}_{i} )} , & ℊ ( {s}_{i} ) = \frac{1}{\begin{matrix}1 + exp \\ ( - {ρ}_{3} {s}_{i} )\end{matrix}} \\ ℊ ( {s}_{i} ) = {( {s}_{i} - {τ}_{1} )}^{2} , & ℊ ( {s}_{i} ) = {( {s}_{i} - {τ}_{2} )}^{2} , & ℊ ( {s}_{i} ) = {( {s}_{i} - {τ}_{3} )}^{2} ,\end{matrix} ,$$

where

the ρ1, τ1, ρ2, τ2, ρ3, and τ3 are normalization coefficients.

Optionally, the characteristic values further include a second characteristic value, and a specific implementation manner of the determining, by the processor 301 and based on the normalized coordinate values of the sample reference regions, characteristic values of the sample reference regions is:

calculating, based on the following formula, the second characteristic value:

$$M ( \hat{B} ) = \frac{1}{p} {D}^{T} D ,$$

where

M(\hat{B}) is the second characteristic value, the quantity of the sample reference regions is p, p is a positive integer less than or equal to n, a matrix D includes the normalized coordinate values of the sample reference regions, the i^{th} row in the matrix D includes normalized coordinate value of the i^{th} reference region in the sample reference regions, and \hat{B} represents the sample reference regions.

In this embodiment of the present invention, because the second characteristic value is obtained by means of calculation based on a matrix that includes a coordinate of sample reference regions, two-dimensional relationships of coordinates of different sample reference regions are comprehensively considered for a coordinate value, of a target region of a to-be-detected object, that is determined based on the second characteristic value, which helps improve object detection accuracy.

Optionally, a specific implementation manner of the determining, by the processor 301 and based on the characteristic values, a coordinate value of the target region corresponding to the to-be-detected object is:

calculating, according to the following formula, the coordinate value of the target region:

$$\begin{matrix}{h}^{1} ( \hat{ℬ} ) = {f}_{0} ( \hat{ℬ} , {Λ}_{0} ) + {f}_{1 } ( \hat{ℬ} , {Λ}_{1} ) + {f}_{2} ( \hat{ℬ} , {Λ}_{2} ) \\ = λ + {Λ}_{1}^{T} u ( \hat{ℬ} ) + {Λ}_{2}^{T} m ( \hat{ℬ} ) \\ = {Λ}^{T} R ( \hat{ℬ} )\end{matrix} ,$$

where

h¹(\hat{B}) is the coordinate value of the target region corresponding to the to-be-detected object, f₀(\hat{B}Λ₀)=λ, f₁(\hat{B},Λ₁)=Λ₁^{T}u(\hat{B}), f₂(\hat{B},Λ₂)=Λ₂^{T}m(\hat{B}), u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B}), m(\hat{B})^{T}]^{T}, and \hat{B} represents the sample reference regions.

Optionally, a value of the coefficient Λ is determined by using the following model:

$${min}_{Λ} \frac{1}{2} {Λ}^{T} Λ + C {\sum }_{k = 1}^{K} {[ max ( 0 , \vert {\hat{z}}_{1}^{k} - {h}^{1} ( {\hat{ℬ}}_{k} ) \vert - ∈ ) ]}^{2} ,$$

where

C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

It can be learned that, in this embodiment of the present invention, after obtaining n reference regions used to identify a to-be-detected object in a to-be-processed image, and n detection accuracy values, of the to-be-detected object, corresponding to the n reference regions, and determining sample reference regions in the n reference regions, a computer device may determine, based on the sample reference regions, a target region corresponding to the to-be-detected object, where the target region is used to identify the to-be-detected object in the to-be-processed image, coincidence degrees of the sample reference regions is greater than a preset threshold, and the coincidence degrees of the sample reference regions is coincidence degrees between the sample reference regions and a reference region that corresponds to a maximum value in the n detection accuracy values. It can be learned that, in this embodiment of the present invention, a reference region with a relatively high region coincidence degree is not simply deleted, and instead, sample reference regions with relatively high quality is used to predict a location of a target region of an object, with a relationship of the sample reference regions being fully considered, which helps improve accuracy of detecting a location of the object.

Being consistent with the foregoing technical solutions, referring to FIG. 4, FIG. 4 is a schematic flowchart of an object detection method according to a method embodiment of the present invention. It should be noted that, although the object detection method disclosed in this method embodiment can be implemented based on an entity apparatus of the computer device shown in FIG. 3, the foregoing example computer device does not constitute a unique limitation on the object detection method disclosed in this method embodiment of the present invention.

As shown in FIG. 4, the object detection method includes the following steps:

S401: A computer device obtains a to-be-processed image.

S402: The computer device obtains, according to the to-be-processed image, n reference regions used to identify a to-be-detected object in the to-be-processed image, and n detection accuracy values, of the to-be-detected object, corresponding to the n reference regions, where n is an integer greater than 1.

The detection accuracy values, of the to-be-detected object, corresponding to the reference regions may be obtained by means of calculation by using a region based convolutional neural network (Region Based Convolutional Neural Network, RCNN) classifier.

S403: The computer device determines sample reference regions in the n reference regions, where coincidence degrees between the sample reference regions and a reference region that corresponds to a maximum value in the n detection accuracy values is greater than a preset threshold.

If a coincidence degree corresponding to two reference regions that completely coincide is 1, the preset threshold may be, for example, 0.99 or 0.98; or if a coincidence degree corresponding to two reference regions that completely coincide is 100, the preset threshold may be, for example, 99, 98, or 95. The preset threshold may be set by a user in advance.

S404: The computer device determines, based on the sample reference regions, a target region corresponding to the to-be-detected object, where the target region is used to identify the to-be-detected object in the to-be-processed image.

It can be learned that, in this embodiment of the present invention, after obtaining n reference regions used to identify a to-be-detected object in a to-be-processed image, and n detection accuracy values, of the to-be-detected object, corresponding to the n reference regions, and determining sample reference regions in the n reference regions, a computer device may determine, based on the sample reference regions, a target region corresponding to the to-be-detected object, where the target region is used to identify the to-be-detected object in the to-be-processed image, coincidence degrees of the sample reference regions is greater than a preset threshold, and the coincidence degrees of the sample reference regions is coincidence degrees between the sample reference regions and a reference region that corresponds to a maximum value in the n detection accuracy values. It can be learned that, in this embodiment of the present invention, a reference region with a relatively high region coincidence degree is not simply deleted, and instead, sample reference regions with relatively high quality is used to predict a location of a target region of an object, with a relationship of the sample reference regions being fully considered, which helps improve accuracy of detecting a location of the object.

Optionally, in this embodiment of the present invention, after the computer device determines the target region corresponding to the to-be-detected object, the computer device is further configured to:

output the to-be-processed image with the target region identified.

Optionally, in this embodiment of the present invention, a specific implementation manner of the determining, by the computer device and based on the sample reference regions, a target region corresponding to the to-be-detected object is:

normalizing, by the computer device, a coordinate value of the sample reference regions, to obtain normalized coordinate values of the sample reference regions, where the coordinate value of the sample reference regions is used to represent the sample reference regions;

determining, by the computer device and based on the normalized coordinate values of the sample reference regions, characteristic values of the sample reference regions; and

determining, by the computer device and based on the characteristic values, a coordinate value used to identify the target region corresponding to the to-be-detected object in the to-be-processed image.

Optionally, in this embodiment of the present invention, a specific implementation manner of the normalizing, by the computer device, a coordinate value of the sample reference regions, to obtain normalized coordinate values of the sample reference regions is:

calculating, by the computer device and based on the following formula, the normalized coordinate values of the sample reference regions:

$${\hat{x}}_{1}^{i} = \frac{{x}_{1}^{i} - \frac{1}{2 Π} {\sum }_{j = 1}^{p} I ( {s}_{j} ) ( {x}_{1}^{j} + {x}_{2}^{j} )}{\frac{1}{Π} {\sum }_{j = 1}^{p} I ( {s}_{j} ) ( {x}_{2}^{j} - {x}_{1}^{j} )} ,$$

where

a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;

x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and \hat{x}₁ⁱ is a normalized horizontal ordinate of the pixel that is located in the upper-left corner of the i^{th} reference region; or

x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and

I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σⱼ₌₁^{p}I(sⱼ), and both i and j are positive integers less than or equal to p.

The preset accuracy value may be set by a user in advance, or may be a reference value obtained by means of calculation according to the maximum value in the n detection accuracy values, which is not uniquely limited in this embodiment of the present invention.

Optionally, in this embodiment of the present invention, the characteristic values include a first characteristic value, and a specific implementation manner of the determining, by the computer device and based on the normalized coordinate values of the sample reference regions, characteristic values of the sample reference regions is:

calculating, by the computer device and based on the following formula, the first characteristic value:

$${u}_{t} = \frac{1}{{Π}_{t}} {\sum }_{i = 1}^{p} {ℊ}_{t} ( {s}_{i} ) {\hat{b}}_{i} ,$$

where

the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and

\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region; or

\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

It should be noted that \hat{b}ᵢ={\hat{x}₁ⁱ,ŷ₁ⁱ,\hat{x}₂ⁱ,ŷ₂ⁱ} in the foregoing formula of uₜ specifically refers to:

if a currently calculated first characteristic value is a first characteristic value corresponding to an x₁ coordinate of the sample reference regions, \hat{b}ᵢ=\hat{x}₁ⁱ; if a currently calculated first characteristic value is a first characteristic value corresponding to a y₁ coordinate of the sample reference regions, \hat{b}ᵢ=ŷ₁ⁱ; if a currently calculated first characteristic value is a first characteristic value corresponding to an x₂ coordinate of the sample reference regions, \hat{b}ᵢ=\hat{x}₂ⁱ; or if a currently calculated first characteristic value is a first characteristic value corresponding to a y₂ coordinate of the sample reference regions, \hat{b}ᵢ=ŷ₂ⁱ, where the x₁ coordinate corresponds to the foregoing x₁^{j} coordinate, and the x₂ coordinate corresponds to the foregoing x₂^{j} coordinate.

Optionally, in this embodiment of the present invention, the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ include at least one of the following:

$$\begin{matrix}ℊ & ( {s}_{i} ) = exp ( {ρ}_{1} {s}_{i} ) , & ℊ & ( {s}_{i} ) = exp ( {ρ}_{2} {s}_{i} ) , \\ ℊ & ( {s}_{i} ) = {( {s}_{i} - {τ}_{1} )}^{\frac{1}{2}} , & ℊ & ( {s}_{i} ) = {( {s}_{i} - {τ}_{2} )}^{\frac{1}{2}} , \\ ℊ & ( {s}_{i} ) = {s}_{i} - {τ}_{1} , & ℊ & ( {s}_{i} ) = {s}_{i} - {τ}_{2} , \\ ℊ & ( {s}_{i} ) = min ( {s}_{i} - {τ}_{1} 4 ) , & ℊ & ( {s}_{i} ) = min ( {s}_{i} - {τ}_{2} 4 ) , \\ ℊ & ( {s}_{i} ) = \frac{1}{1 + exp ( - {ρ}_{1} {s}_{i} )} , & ℊ & ( {s}_{i} ) = \frac{1}{1 + exp ( - {ρ}_{2} {s}_{i} )} , \\ ℊ & ( {s}_{i} ) = {( {s}_{i} - {τ}_{1} )}^{2} , & ℊ & ( {s}_{i} ) = {( {s}_{i} - {τ}_{2} )}^{2} ,\end{matrix}$$

$$\begin{matrix}ℊ & ( {s}_{i} ) = exp ( {ρ}_{3} {s}_{i} ) , \\ ℊ & ( {s}_{i} ) = {( {s}_{i} - {τ}_{3} )}^{\frac{1}{2}} , \\ ℊ & ( {s}_{i} ) = {s}_{i} - {τ}_{3} \\ ℊ & ( {s}_{i} ) = min ( {s}_{i} - {τ}_{3} 4 ) , \\ ℊ & ( {s}_{i} ) = \frac{1}{1 + exp ( - {ρ}_{3} {s}_{i} )} \\ ℊ & ( {s}_{i} ) = {( {s}_{i} - {τ}_{3} )}^{2} ,\end{matrix} ,$$

where

the ρ1, τ1, ρ2, τ2, ρ3, and τ3 are normalization coefficients.

Optionally, in this embodiment of the present invention, the characteristic values further include a second characteristic value, and a specific implementation manner of the determining, by the computer device and based on the normalized coordinate values of the sample reference regions, characteristic values of the sample reference regions is:

calculating, by the computer device and based on the following formula, the second characteristic value:

$$M ( \hat{ℬ} ) = \frac{1}{p} {D}^{T} D ,$$

where

M(\hat{B}) is the second characteristic value, the quantity of the sample reference regions is p, p is a positive integer less than or equal to n, a matrix D includes the normalized coordinate values of the sample reference regions, the i^{th} row in the matrix D includes normalized coordinate value of the i^{th} reference region in the sample reference regions, and \hat{B} represents the sample reference regions.

Optionally, in this embodiment of the present invention, a specific implementation manner of the determining, by the computer device and based on the characteristic values, a coordinate value of the target region corresponding to the to-be-detected object is:

calculating, by the computer device and according to the following formula, the coordinate value of the target region:

$$\begin{matrix}{h}^{1} ( \hat{ℬ} ) = {f}_{0} ( \hat{ℬ} , {Λ}_{0} ) + {f}_{1 } ( \hat{ℬ} , {Λ}_{1} ) + {f}_{2} ( \hat{ℬ} , {Λ}_{2} ) \\ = λ + {Λ}_{1}^{T} u ( \hat{ℬ} ) + {Λ}_{2}^{T} m ( \hat{ℬ} ) \\ = {Λ}^{T} R ( \hat{ℬ} )\end{matrix} ,$$

where

h¹(\hat{B}) is the coordinate value of the target region corresponding to the to-be-detected object, f₀(\hat{B}Λ₀)=λ, f₁(\hat{B},Λ₁)=Λ₁^{T}u(\hat{B}), f₂(\hat{B},Λ₂)=Λ₂^{T}m(\hat{B}), u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B}), m(\hat{B})^{T}]^{T}, and \hat{B} represents the sample reference regions.

Optionally, in this embodiment of the present invention, a value of the coefficient Λ is determined by using the following model:

$${min}_{Λ} \frac{1}{2} {Λ}^{T} Λ + C {\sum }_{k = 1}^{K} {[ max ( 0 , \vert {\hat{z}}_{1}^{k} - {h}^{1} ( {\hat{ℬ}}_{k} ) \vert - ∈ ) ]}^{2} ,$$

where

C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

Some or all of the steps performed by the foregoing computer device may be specifically implemented by the computer device by executing software modules (program code) in the foregoing memory. For example, step S401 and step S402 may be implemented by the computer device by executing the obtaining module shown in FIG. 3; step S403 may be implemented by the computer device by executing the first determining module shown in FIG. 3; and step S404 may be implemented by the computer device by executing the second determining module shown in FIG. 3.

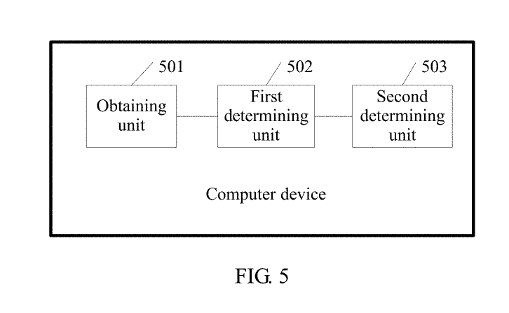

The following is an apparatus embodiment of the present invention. Referring to FIG. 5, FIG. 5 is a composition block diagram of functional units of a computer device according to an apparatus embodiment of the present invention. As shown in FIG. 5, the computer device includes an obtaining unit 501, a first determining unit 502, and a second determining unit 503, where

the obtaining unit 501 is configured to obtain a to-be-processed image;

the obtaining unit 501 is further configured to obtain, according to the to-be-processed image, n reference regions used to identify a to-be-detected object in the to-be-processed image, and n detection accuracy values, of the to-be-detected object, corresponding to the n reference regions, where n is an integer greater than 1;

the first determining unit 502 is configured to determine sample reference regions in the n reference regions, where coincidence degrees between the sample reference regions and a reference region that corresponds to a maximum value in the n detection accuracy values is greater than a preset threshold; and

the second determining unit 503 is configured to determine, based on the sample reference regions, a target region corresponding to the to-be-detected object, where the target region is used to identify the to-be-detected object in the to-be-processed image.

Optionally, the second determining unit 503 includes:

a normalizing unit, configured to normalize a coordinate value of the sample reference regions, to obtain normalized coordinate values of the sample reference regions, where the coordinate value of the sample reference regions is used to represent the sample reference regions;

a characteristic value determining unit, configured to determine, based on the normalized coordinate values of the sample reference regions, characteristic values of the sample reference regions; and

a coordinate value determining unit, configured to determine, based on the characteristic values, a coordinate value used to identify the target region corresponding to the to-be-detected object in the to-be-processed image.

Optionally, the normalizing unit is specifically configured to:

calculate, based on the following formula, the normalized coordinate values of the sample reference regions:

$${\hat{x}}_{1}^{i} = \frac{{x}_{1}^{i} - \frac{1}{2 Π} {\sum }_{j = 1}^{p} I ( {s}_{j} ) ( {x}_{1}^{j} + {x}_{2}^{j} )}{\frac{1}{Π} {\sum }_{j = 1}^{p} I ( {s}_{j} ) ( {x}_{2}^{j} - {x}_{1}^{j} )} ,$$

where

a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;

x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and \hat{x}₁ⁱ is a normalized horizontal ordinate of the pixel that is located in the upper-left corner of the i^{th} reference region; or

x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and

I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σⱼ₌₁^{p}I(sⱼ), and both i and j are positive integers less than or equal to p.

The preset accuracy value may be set by a user in advance, or may be a reference value obtained by means of calculation according to the maximum value in the n detection accuracy values, which is not uniquely limited in this embodiment of the present invention.

Optionally, the characteristic values include a first characteristic value, and the characteristic value determining unit is specifically configured to:

calculate, based on the following formula, the first characteristic value:

$${u}_{t} = \frac{1}{{Π}_{t}} {\sum }_{i = 1}^{p} {ℊ}_{t} ( {s}_{i} ) {\hat{b}}_{i} ,$$

where

the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and

\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region; or

\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

It should be noted that \hat{b}ᵢ={\hat{x}₁ⁱ,ŷ₁ⁱ,\hat{x}₂ⁱ,ŷ₂ⁱ} in the foregoing formula of uₜ specifically refers to:

if a currently calculated first characteristic value is a first characteristic value corresponding to an x₁ coordinate of the sample reference regions, \hat{b}ᵢ=\hat{x}₁ⁱ; if a currently calculated first characteristic value is a first characteristic value corresponding to a y₁ coordinate of the sample reference regions, \hat{b}ᵢ=ŷ₁ⁱ; if a currently calculated first characteristic value is a first characteristic value corresponding to an x₂ coordinate of the sample reference regions, \hat{b}ᵢ=\hat{x}₂ⁱ; or if a currently calculated first characteristic value is a first characteristic value corresponding to a y₂ coordinate of the sample reference regions, \hat{b}ᵢ=ŷ₂ⁱ, where the x₁ coordinate corresponds to the foregoing x₁^{j} coordinate, and the x₂ coordinate corresponds to the foregoing x₂^{j} coordinate.

Optionally, the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ include at least one of the following:

$$\begin{matrix}ℊ & ( {s}_{i} ) = exp ( {ρ}_{1} {s}_{i} ) , & ℊ & ( {s}_{i} ) = exp ( {ρ}_{2} {s}_{i} ) , \\ ℊ & ( {s}_{i} ) = {( {s}_{i} - {τ}_{1} )}^{\frac{1}{2}} , & ℊ & ( {s}_{i} ) = {( {s}_{i} - {τ}_{2} )}^{\frac{1}{2}} , \\ ℊ & ( {s}_{i} ) = {s}_{i} - {τ}_{1} , & ℊ & ( {s}_{i} ) = {s}_{i} - {τ}_{2} , \\ ℊ & ( {s}_{i} ) = min ( {s}_{i} - {τ}_{1} 4 ) , & ℊ & ( {s}_{i} ) = min ( {s}_{i} - {τ}_{2} 4 ) , \\ ℊ & ( {s}_{i} ) = \frac{1}{1 + exp ( - {ρ}_{1} {s}_{i} )} , & ℊ & ( {s}_{i} ) = \frac{1}{1 + exp ( - {ρ}_{2} {s}_{i} )} , \\ ℊ & ( {s}_{i} ) = {( {s}_{i} - {τ}_{1} )}^{2} , & ℊ & ( {s}_{i} ) = {( {s}_{i} - {τ}_{2} )}^{2} ,\end{matrix}$$

$$\begin{matrix}ℊ & ( {s}_{i} ) = exp ( {ρ}_{3} {s}_{i} ) , \\ ℊ & ( {s}_{i} ) = {( {s}_{i} - {τ}_{3} )}^{\frac{1}{2}} , \\ ℊ & ( {s}_{i} ) = {s}_{i} - {τ}_{3} \\ ℊ & ( {s}_{i} ) = min ( {s}_{i} - {τ}_{3} 4 ) , \\ ℊ & ( {s}_{i} ) = \frac{1}{1 + exp ( - {ρ}_{3} {s}_{i} )} \\ ℊ & ( {s}_{i} ) = {( {s}_{i} - {τ}_{3} )}^{2} ,\end{matrix} ,$$

where

the ρ1, τ1, ρ2, τ2, ρ3, and τ3 are normalization coefficients.

Optionally, the characteristic values further include a second characteristic value, and the characteristic value determining unit is specifically configured to:

calculate, based on the following formula, the second characteristic value:

$$M ( \hat{ℬ} ) = \frac{1}{p} {D}^{T} D ,$$

where

M(\hat{B}) is the second characteristic value, the quantity of the sample reference regions is p, p is a positive integer less than or equal to n, a matrix D includes the normalized coordinate values of the sample reference regions, the i^{th} row in the matrix D includes normalized coordinate value of the i^{th} reference region in the sample reference regions, and \hat{B} represents the sample reference regions.

Optionally, the coordinate value determining unit is specifically configured to:

calculate, according to the following formula, the coordinate value of the target region:

$$\begin{matrix}{h}^{1} ( \hat{ℬ} ) = {f}_{0} ( \hat{ℬ} , {Λ}_{0} ) + {f}_{1 } ( \hat{ℬ} , {Λ}_{1} ) + {f}_{2} ( \hat{ℬ} , {Λ}_{2} ) \\ = λ + {Λ}_{1}^{T} u ( \hat{ℬ} ) + {Λ}_{2}^{T} m ( \hat{ℬ} ) \\ = {Λ}^{T} R ( \hat{ℬ} )\end{matrix} ,$$

where

h¹(\hat{B}) is the coordinate value of the target region corresponding to the to-be-detected object, f₀(\hat{B}Λ₀)=λ, f₁(\hat{B},Λ₁)=Λ₁^{T}u(\hat{B}), f₂(\hat{B},Λ₂)=Λ₂^{T}m(\hat{B}), u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B}), m(\hat{B})^{T}]^{T}, and \hat{B} represents the sample reference regions.

Optionally, a value of the coefficient Λ is determined by using the following model:

$${min}_{Λ} \frac{1}{2} {Λ}^{T} Λ + C {\sum }_{k = 1}^{K} {[ max ( 0 , \vert {\hat{z}}_{1}^{k} - {h}^{1} ( {\hat{ℬ}}_{k} ) \vert - ∈ ) ]}^{2} ,$$

where

C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

It should be noted that the computer device described in this functional unit apparatus embodiment of the present invention is represented in a form of functional units. The term “unit” used herein should be understood as a meaning as broadest as possible. The unit is an object that is used to implement a function of each “unit”, and may be, for example, an integrated circuit ASIC or a single circuit; or is a processor (a shared processor, a dedicated processor, or a chipset) and a memory that are used to execute one or multiple software or firmware programs, a combinational logic circuit, and/or another appropriate component that provides and implements the foregoing functions.

For example, a person skilled in the art may know that a composition form of a hardware carrier of the computer device may be specifically the computer device shown in FIG. 3, where

a function of the obtaining unit 501 may be implemented by the processor 301 and the memory 303 in the computer device, where specifically, the processor 301 runs the obtaining module in the memory 303 to obtain a to-be-processed image and obtain, according to the to-be-processed image, n reference regions used to identify a to-be-detected object in the to-be-processed image, and n detection accuracy values, of the to-be-detected object, corresponding to the n reference regions;

a function of the first determining unit 502 may be implemented by the processor 301 and the memory 303 in the computer device, where specifically, the processor 301 runs the first determining module in the memory 303 to determine sample reference regions in the n reference regions; and

a function of the second determining unit 503 may be implemented by the processor 301 and the memory 303 in the computer device, where specifically, the processor 301 runs the second determining module in the memory 303 to determine, based on the sample reference regions, a target region corresponding to the to-be-detected object.

It can be learned that, in this embodiment of the present invention, an obtaining unit of a computer device disclosed in this embodiment of the present invention first obtains a to-be-processed image and obtains, according to the to-be-processed image, n reference regions used to identify a to-be-detected object in the to-be-processed image, and n detection accuracy values, of the to-be-detected object, corresponding to the n reference regions; then, a first determining unit of the computer device determines sample reference regions in the n reference regions; and finally, a second determining unit of the computer device determines, based on the sample reference regions, a target region corresponding to the to-be-detected object, where coincidence degrees of the sample reference regions is greater than a preset threshold, and the coincidence degrees of the sample reference regions is coincidence degrees between the sample reference regions and a reference region that corresponds to a maximum value in the n detection accuracy values. It can be learned that, in this embodiment of the present invention, a reference region with a relatively high region coincidence degree is not simply deleted, and instead, sample reference regions with relatively high quality is used to predict a location of a target region of an object, with a relationship of the sample reference regions being fully considered, which helps improve accuracy of detecting a location of the object.

A person of ordinary skill in the art may understand that all or some of the steps of the methods in the embodiments may be implemented by a program instructing relevant hardware. The program may be stored in a computer readable storage medium. The storage medium may include a flash memory, a read-only memory (Read-Only Memory, ROM), a random access memory (Random Access Memory, RAM), a magnetic disk, an optical disc, or the like.

The object detection method and the computer device that are disclosed in the embodiments of the present invention have been described in detail above. The principle and the implementation manners of the present invention are described herein by using specific examples. The descriptions about the embodiments are merely provided to help understand the method and the core idea of the present invention. In addition, a person of ordinary skill in the art can make variations and modifications to the present invention regarding the specific implementation manners and the application scope, according to the idea of the present invention. Therefore, the content of this specification shall not be construed as a limitation on the present invention.

What is claimed is:

1. An object detection method, comprising:
obtaining a to-be-processed image;
obtaining, according to the to-be-processed image, n reference regions used to identify a to-be-detected object in the to-be-processed image, and n detection accuracy values, of the to-be-detected object, corresponding to the n reference regions, wherein n is an integer greater than 1;
determining sample reference regions in the n reference regions, wherein coincidence degrees between the sample reference regions and a reference region that corresponds to a maximum value in the n detection accuracy values is greater than a preset threshold; and
determining, based on the sample reference regions, a target region corresponding to the to-be-detected object, wherein the target region is used to identify the to-be-detected object in the to-be-processed image.

2. The method according to claim 1, wherein the determining, based on the sample reference regions, a target region corresponding to the to-be-detected object comprises:
normalizing coordinate values of the sample reference regions, to obtain normalized coordinate values of the sample reference regions, wherein the coordinate value of the sample reference regions is used to represent the sample reference regions;
determining, based on the normalized coordinate values of the sample reference regions, characteristic values of the sample reference regions; and
determining, based on the characteristic values, a coordinate value used to identify the target region corresponding to the to-be-detected object in the to-be-processed image.

3. The method according to claim 2, wherein the normalizing coordinate values of the sample reference regions, to obtain normalized coordinate values of the sample reference regions comprises:
calculating, based on the following formula, the normalized coordinate values of the sample reference regions:
$${\hat{x}}_{1}^{i} = \frac{{x}_{1}^{i} - \frac{1}{2 Π} {\sum }_{j = 1}^{p} I ( {s}_{j} ) ( {x}_{1}^{j} + {x}_{2}^{j} )}{\frac{1}{Π} {\sum }_{j = 1}^{p} I ( {s}_{j} ) ( {x}_{2}^{j} - {x}_{1}^{j} )} ,$$
wherein
a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;
x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and \hat{x}₁ⁱ is a normalized horizontal ordinate of the pixel that is located in the upper-left corner of the i^{th} reference region; or
x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and
I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σⱼ₌₁^{p}I(sⱼ), and both i and j are positive integers less than or equal to p.

4. The method according to claim 2, wherein the characteristic values comprise a first characteristic value, and the determining, based on the normalized coordinate values of the sample reference regions, characteristic values of the sample reference regions comprises:
calculating, based on the following formula, the first characteristic value:
$${u}_{l} = \frac{1}{{\prod }_{t} } {\sum }_{i = 1}^{P} {g}_{t} ( {s}_{i} ) {\hat{b}}_{i} ,$$
wherein
the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and
\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region.

5. The method according to claim 4, wherein the first characteristic value u(\hat{B})=[u₁, . . . u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ comprise at least one of the following:
$$\begin{matrix}g ( {s}_{i} ) = exp ( {ρ}_{1} {s}_{i} ) , & g ( {s}_{i} ) = exp ( {ρ}_{2} {s}_{i} ) , & g ( {s}_{i} ) = exp ( {ρ}_{3} {s}_{i} ) , \\ g ( {s}_{i} ) = {( {s}_{i} - {τ}_{1} )}^{\frac{1}{2}} , & g ( {s}_{i} ) = {( {s}_{i} - {τ}_{2} )}^{\frac{1}{2}} , & g ( {s}_{i} ) = {( {s}_{i} - {τ}_{3} )}^{\frac{1}{2}} , \\ g ( {s}_{i} ) = {s}_{i} - {τ}_{1} , & g ( {s}_{i} ) = {s}_{i} - {τ}_{2} , & g ( {s}_{i} ) = {s}_{i} - {τ}_{3} , \\ g ( {s}_{i} ) = min ( {s}_{i} - {τ}_{1} , 4 ) , & g ( {s}_{i} ) = min ( {s}_{i} - {τ}_{2} , 4 ) , & g ( {s}_{i} ) = min ( {s}_{i} - {τ}_{3} , 4 ) , \\ g ( {s}_{i} ) = \frac{1}{1 + exp ( - {ρ}_{1} {s}_{i} )} , & g ( {s}_{i} ) = \frac{1}{1 + exp ( - {ρ}_{2} {s}_{i} )} , & g ( {s}_{i} ) = \frac{1}{1 + exp ( - {ρ}_{3} {s}_{i} )} \\ g ( {s}_{i} ) = {( {s}_{i} - {τ}_{1} )}^{2} , & g ( {s}_{i} ) = {( {s}_{i} - {τ}_{2} )}^{2} , & g ( {s}_{i} ) = {( {s}_{i} - {τ}_{3} )}^{2} ,\end{matrix} ,$$
wherein
the ρ1, τ1, ρ2, τ2, ρ3, and τ3 are normalization coefficients.

6. The method according to claim 2, wherein the characteristic values further comprise a second characteristic value, and the determining, based on the normalized coordinate values of the sample reference regions, characteristic values of the sample reference regions comprises:
calculating, based on the following formula, the second characteristic value:
$$M ( \hat{B} ) = \frac{1}{p} {D}^{T} D ,$$
wherein
M(\hat{B}) is the second characteristic value, the quantity of the sample reference regions is p, p is a positive integer less than or equal to n, a matrix D comprises the normalized coordinate values of the sample reference regions, the i^{th} row in the matrix D comprises normalized coordinate value of the i^{th} reference region in the sample reference regions, and \hat{B} represents the sample reference regions.

7. The method according to claim 6, wherein the determining, based on the characteristic values, a coordinate value of the target region corresponding to the to-be-detected object comprises:
calculating, according to the following formula, the coordinate value of the target region:
$$\begin{matrix}{h}^{1} ( \hat{B} ) = λ + {Λ}_{1}^{T} u ( \hat{B} ) + {Λ}_{2}^{T} m ( \hat{B} ) \\ = {Λ}^{T} R ( \hat{B} )\end{matrix} ,$$
wherein
h¹(\hat{B}) is the coordinate value of the target region corresponding to the to-be-detected object, u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B})^{T}, m(\hat{B})^{T}]^{T}, and \hat{B} represents the sample reference regions.

8. The method according to claim 7, wherein a value of the coefficient Λ is determined by using the following model:
$${min}_{Λ} \frac{1}{2} {Λ}^{T} Λ + C {\sum }_{k = 1}^{K} {[ max ( 0 , \vert {\hat{Z}}_{1}^{k} - {h}^{1} ( {\hat{B}}_{k} ) \vert - ∈ ) ]}^{2} ,$$
wherein
C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

9. A computer device, comprising:
a memory that stores executable program code; and
a processor that is coupled with the memory,
wherein the processor invokes the executable program code stored in the memory and performs the following steps:
obtaining a to-be-processed image;
obtaining, according to the to-be-processed image, n reference regions used to identify a to-be-detected object in the to-be-processed image, and n detection accuracy values, of the to-be-detected object, corresponding to the n reference regions, wherein n is an integer greater than 1;
determining sample reference regions in the n reference regions, wherein coincidence degrees between the sample reference regions and a reference region that corresponds to a maximum value in the n detection accuracy values is greater than a preset threshold; and
determining, based on the sample reference regions, a target region corresponding to the to-be-detected object, wherein the target region is used to identify the to-be-detected object in the to-be-processed image.

10. The computer device according to claim 9, wherein a specific implementation manner of the determining, by the processor and based on the sample reference regions, a target region corresponding to the to-be-detected object is:
normalizing coordinate values of the sample reference regions, to obtain normalized coordinate values of the sample reference regions, wherein the coordinate value of the sample reference regions is used to represent the sample reference regions;
determining, based on the normalized coordinate values of the sample reference regions, characteristic values of the sample reference regions; and
determining, based on the characteristic values, a coordinate value used to identify the target region corresponding to the to-be-detected object in the to-be-processed image.

11. The computer device according to claim 10, wherein a specific implementation manner of the normalizing, by the processor, a coordinate value of the sample reference regions, to obtain normalized coordinate values of the sample reference regions is:
calculating, based on the following formula, the normalized coordinate values of the sample reference regions:
$${\hat{x}}_{1}^{i} = \frac{{x}_{1}^{i} - \frac{1}{2 Π} {\sum }_{j = 1}^{p} I ( {s}_{j} ) ( {x}_{1}^{j} + {x}_{2}^{j} )}{\frac{1}{Π} {\sum }_{j = 1}^{p} I ( {s}_{j} ) ( {x}_{2}^{j} - {x}_{1}^{j} )} ,$$
wherein
a quantity of the sample reference regions is p, p is a positive integer less than or equal to n, and x₁ⁱ is a horizontal coordinate, in the to-be-processed image, of a pixel that is located in an upper-left corner of the i^{th} reference region in the sample reference regions;
x₁^{j} is a horizontal coordinate, in the to-be-processed image, of a pixel that is located in an upper-left corner of the j^{th} reference region in the sample reference regions, x₂^{j} is a horizontal coordinate, in the to-be-processed image, of a pixel that is located in a lower-right corner of the j^{th} reference region, and \hat{x}₁ⁱ is a normalized horizontal ordinate of the pixel that is located in the upper-left corner of the i^{th} reference region; or
x₁^{j} is a horizontal coordinate, in the to-be-processed image, of a pixel that is located in a lower-left corner of the j^{th} reference region, x₂^{j} is a horizontal coordinate, in the to-be-processed image, of a pixel that is located in an upper-right corner of the j^{th} reference region, and \hat{x}₁ⁱ is a normalized horizontal ordinate of a pixel that is located in a lower-left corner of the i^{th} reference region; and
I(sⱼ) is an indicator function, where when a detection accuracy value sⱼ corresponding to the j^{th} reference region is greater than a preset accuracy value, I(sⱼ) is 1, when a detection accuracy value sⱼ corresponding to the j^{th} reference region is less than or equal to the preset accuracy value, I(sⱼ) is 0, Π=Σⱼ₌₁^{p}I(sⱼ), and both i and j are positive integers less than or equal to p.

12. The computer device according to claim 10, wherein the characteristic values comprise a first characteristic value, and a specific implementation manner of the determining, by the processor and based on the normalized coordinate values of the sample reference regions, characteristic values of the sample reference regions is:
calculating, based on the following formula, the first characteristic value:
$${u}_{i} = \frac{1}{{\prod }_{i}} {\sum }_{i = 1}^{p} {g}_{t} ( {s}_{i} ) {\hat{b}}_{i} ,$$
wherein
the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and
\hat{x}₁ⁱ is the normalized horizontal coordinate, in the to-be-processed image, of the pixel that is located in the upper-left corner of the i^{th} reference region in the sample reference regions, ŷ₁ⁱ is a normalized vertical coordinate, in the to-be-processed image, of the pixel that is located in the upper-left corner of the i^{th} reference region, \hat{x}₂ⁱ is a normalized horizontal coordinate, in the to-be-processed image, of a pixel that is located in a lower-right corner of the i^{th} reference region, and ŷ₂ⁱ is a normalized vertical coordinate, in the to-be-processed image, of the pixel that is located in the lower-right corner of the i^{th} reference region.

13. The computer device according to claim 12, wherein the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ comprise at least one of the following:
$$\begin{matrix}g ( {s}_{i} ) = exp ( {ρ}_{1} {s}_{i} ) , & g ( {s}_{i} ) = exp ( {ρ}_{2} {s}_{i} ) , & g ( {s}_{i} ) = exp ( {ρ}_{3} {s}_{i} ) , \\ g ( {s}_{i} ) = {( {s}_{i} - {τ}_{1} )}^{\frac{1}{2}} , & g ( {s}_{i} ) = {( {s}_{i} - {τ}_{2} )}^{\frac{1}{2}} , & g ( {s}_{i} ) = {( {s}_{i} - {τ}_{3} )}^{\frac{1}{2}} , \\ g ( {s}_{i} ) = {s}_{i} - {τ}_{1} , & g ( {s}_{i} ) = {s}_{i} - {τ}_{2} , & g ( {s}_{i} ) = {s}_{i} - {τ}_{3} , \\ g ( {s}_{i} ) = min ( {s}_{i} - {τ}_{1} , 4 ) , & g ( {s}_{i} ) = min ( {s}_{i} - {τ}_{2} , 4 ) , & g ( {s}_{i} ) = min ( {s}_{i} - {τ}_{3} , 4 ) , \\ g ( {s}_{i} ) = \frac{1}{1 + exp ( - {ρ}_{1} {s}_{i} )} , & g ( {s}_{i} ) = \frac{1}{1 + exp ( - {ρ}_{2} {s}_{i} )} , & g ( {s}_{i} ) = \frac{1}{1 + exp ( - {ρ}_{3} {s}_{i} )} \\ g ( {s}_{i} ) = {( {s}_{i} - {τ}_{1} )}^{2} , & g ( {s}_{i} ) = {( {s}_{i} - {τ}_{2} )}^{2} , & g ( {s}_{i} ) = {( {s}_{i} - {τ}_{3} )}^{2} ,\end{matrix} ,$$
wherein
the ρ1, τ1, ρ2, τ2, ρ3, and τ3 are normalization coefficients.

14. The computer device according to claim 10, wherein the characteristic values further comprise a second characteristic value, and a specific implementation manner of the determining, by the processor and based on the normalized coordinate values of the sample reference regions, characteristic values of the sample reference regions is:
calculating, based on the following formula, the second characteristic value:
$$M ( \hat{B} ) = \frac{1}{p} {D}^{T} D ,$$
wherein
M(\hat{B}) is the second characteristic value, the quantity of the sample reference regions is p, p is a positive integer less than or equal to n, a matrix D comprises the normalized coordinate values of the sample reference regions, the i^{th} row in the matrix D comprises normalized coordinate value of the i^{th} reference region in the sample reference regions, and \hat{B} represents the sample reference regions.

15. The computer device according to claim 14, wherein a specific implementation manner of the determining, by the processor and based on the characteristic values, a coordinate value of the target region corresponding to the to-be-detected object is:
calculating, according to the following formula, the coordinate value of the target region:
$$\begin{matrix}{h}^{1} ( \hat{B} ) = λ + {Λ}_{1}^{T} u ( \hat{B} ) + {Λ}_{2}^{T} m ( \hat{B} ) \\ = {Λ}^{T} R ( \hat{B} )\end{matrix} ,$$
wherein
h¹(\hat{B}) is the coordinate value of the target region corresponding to the to-be-detected object, u(\hat{B}) is the first characteristic value, m(\hat{B})^{T} is a vector form of the second characteristic value M(\hat{B}), λ, Λ₁, and Λ₂ are coefficients, Λ=[λ,Λ₁^{T},Λ₂^{T}]^{T}, R(\hat{B})=[1, u(\hat{B})^{T}, m(\hat{B})^{T}]^{T}, and \hat{B} represents the sample reference regions.

16. The computer device according to claim 15, wherein a value of the coefficient Λ is determined by using the following model:
$${min}_{Λ} \frac{1}{2} {Λ}^{T} Λ + C {\sum }_{k = 1}^{K} {[ max ( 0 , \vert {\hat{Z}}_{1}^{k} - {h}^{1} ( {\hat{B}}_{k} ) \vert - ∈ ) ]}^{2} ,$$
wherein
C and ε are preset values, K is a quantity of pre-stored training sets, \hat{Z}₁^{k} is a preset coordinate value of a target region corresponding to a reference region in the k^{th} training set of the K training sets, and \hat{B}ₖ represents the reference region in the k^{th} training set.

17. The method according to claim 2, wherein the characteristic values comprise a first characteristic value, and the determining, based on the normalized coordinate values of the sample reference regions, characteristic values of the sample reference regions comprises:
calculating, based on the following formula, the first characteristic value:
$${u}_{l} = \frac{1}{{\prod }_{t} } {\sum }_{i = 1}^{P} {g}_{i} ( {s}_{i} ) {\hat{b}}_{i} ,$$
wherein
the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and
\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

18. The method according to claim 17, wherein the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ comprise at least one of the following:
$$\begin{matrix}g ( {s}_{i} ) = exp ( {ρ}_{1} {s}_{i} ) , & g ( {s}_{i} ) = exp ( {ρ}_{2} {s}_{i} ) , & g ( {s}_{i} ) = exp ( {ρ}_{3} {s}_{i} ) , \\ g ( {s}_{i} ) = {( {s}_{i} - {τ}_{1} )}^{\frac{1}{2}} , & g ( {s}_{i} ) = {( {s}_{i} - {τ}_{2} )}^{\frac{1}{2}} , & g ( {s}_{i} ) = {( {s}_{i} - {τ}_{3} )}^{\frac{1}{2}} , \\ g ( {s}_{i} ) = {s}_{i} - {τ}_{1} , & g ( {s}_{i} ) = {s}_{i} - {τ}_{2} , & g ( {s}_{i} ) = {s}_{i} - {τ}_{3} , \\ g ( {s}_{i} ) = min ( {s}_{i} - {τ}_{1} , 4 ) , & g ( {s}_{i} ) = min ( {s}_{i} - {τ}_{2} , 4 ) , & g ( {s}_{i} ) = min ( {s}_{i} - {τ}_{3} , 4 ) , \\ g ( {s}_{i} ) = \frac{1}{1 + exp ( - {ρ}_{1} {s}_{i} )} , & g ( {s}_{i} ) = \frac{1}{1 + exp ( - {ρ}_{2} {s}_{i} )} , & g ( {s}_{i} ) = \frac{1}{1 + exp ( - {ρ}_{3} {s}_{i} )} \\ g ( {s}_{i} ) = {( {s}_{i} - {τ}_{1} )}^{2} , & g ( {s}_{i} ) = {( {s}_{i} - {τ}_{2} )}^{2} , & g ( {s}_{i} ) = {( {s}_{i} - {τ}_{3} )}^{2} ,\end{matrix} ,$$
wherein
the ρ1, τ1, ρ2, τ2, ρ3, and τ3 are normalization coefficients.

19. The computer device according to claim 10, wherein the characteristic values comprise a first characteristic value, and a specific implementation manner of the determining, by the processor and based on the normalized coordinate values of the sample reference regions, characteristic values of the sample reference regions is:
calculating, based on the following formula, the first characteristic value:
$${u}_{l} = \frac{1}{{\prod }_{t} } {\sum }_{i = 1}^{P} {g}_{i} ( {s}_{i} ) {\hat{b}}_{i} ,$$
wherein
the quantity of the sample reference regions is p, p is a positive integer less than or equal to n, the first characteristic value u(\hat{B}) includes uₜ, Πₜ=Σᵢ₌₁^{p}gₜ(sᵢ), sᵢ is a detection accuracy value corresponding to the i^{th} reference region in the sample reference regions, a function gₜ(sᵢ) is a function of sᵢ, the function gₜ(sᵢ) is used as a weighting function of \hat{b}ᵢ, \hat{b}ᵢ is the normalized coordinate values of the sample reference regions, i is a positive integer less than or equal to p, \hat{b}ᵢ={\hat{x}₁ⁱ,ŷ₁ⁱ,\hat{x}₂ⁱ,ŷ₂ⁱ}, and \hat{B} represents the sample reference regions; and
\hat{x}₁ⁱ is the normalized horizontal coordinate, in the to-be-processed image, of the pixel that is located in the lower-left corner of the i^{th} reference region in the sample reference regions, ŷ₁ⁱ is a normalized vertical coordinate, in the to-be-processed image, of the pixel that is located in the lower-left corner of the i^{th} reference region, \hat{x}₂ⁱ is a normalized horizontal coordinate, in the to-be-processed image, of a pixel that is located in an upper-right corner of the i^{th} reference region, and ŷ₂ⁱ is a normalized vertical coordinate, in the to-be-processed image, of the pixel that is located in the upper-right corner of the i^{th} reference region.

20. The computer device according to claim 19, wherein the first characteristic value u(\hat{B})=[u₁, . . . , u_{d}]^{T}, d is a positive integer, t is a positive integer less than or equal to d, uₜ is the t^{th} characteristic value of the first characteristic value, the function gₜ(sᵢ) is the t^{th} weighting function of weighting functions of \hat{b}ᵢ, and the weighting functions of \hat{b}ᵢ comprise at least one of the following:
$$\begin{matrix}g ( {s}_{i} ) = exp ( {ρ}_{1} {s}_{i} ) , & g ( {s}_{i} ) = exp ( {ρ}_{2} {s}_{i} ) , & g ( {s}_{i} ) = exp ( {ρ}_{3} {s}_{i} ) , \\ g ( {s}_{i} ) = {( {s}_{i} - {τ}_{1} )}^{\frac{1}{2}} , & g ( {s}_{i} ) = {( {s}_{i} - {τ}_{2} )}^{\frac{1}{2}} , & g ( {s}_{i} ) = {( {s}_{i} - {τ}_{3} )}^{\frac{1}{2}} , \\ g ( {s}_{i} ) = {s}_{i} - {τ}_{1} , & g ( {s}_{i} ) = {s}_{i} - {τ}_{2} , & g ( {s}_{i} ) = {s}_{i} - {τ}_{3} , \\ g ( {s}_{i} ) = min ( {s}_{i} - {τ}_{1} , 4 ) , & g ( {s}_{i} ) = min ( {s}_{i} - {τ}_{2} , 4 ) , & g ( {s}_{i} ) = min ( {s}_{i} - {τ}_{3} , 4 ) , \\ g ( {s}_{i} ) = \frac{1}{1 + exp ( - {ρ}_{1} {s}_{i} )} , & g ( {s}_{i} ) = \frac{1}{1 + exp ( - {ρ}_{2} {s}_{i} )} , & g ( {s}_{i} ) = \frac{1}{1 + exp ( - {ρ}_{3} {s}_{i} )} \\ g ( {s}_{i} ) = {( {s}_{i} - {τ}_{1} )}^{2} , & g ( {s}_{i} ) = {( {s}_{i} - {τ}_{2} )}^{2} , & g ( {s}_{i} ) = {( {s}_{i} - {τ}_{3} )}^{2} ,\end{matrix} ,$$
wherein
the ρ1, τ1, ρ2, τ2, ρ3, and τ3 are normalization coefficients.
